(19) United States
(12) Patent Application Publication
(10) Pub. No.: US 2006/0006637 A1
(43) Pub. Date: Jan. 12, 2006

(54) Web printed booklet containing advertisements on cover pages including directors to interior advertisements

(76) Inventor: Andrew V. DeAngelis, Troy, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/177,963

(22) Filed: Jul. 8, 2005

Related U.S. Application Data
(60) Provisional application No. 60/586,443, filed on Jul. 8, 2004.

(51) Int. Cl. B42D 1/00

(52) U.S. Cl. 281/15.1

(57) ABSTRACT

A booklet containing television program schedule listings and advertisements, of the type distributed by newspapers on a weekly basis, is printed by a web printing process on primarily newsprint. The booklet contains a front and back cover, and a partial cover, including director sections to ads contained within the booklet.

### RELATED APPLICATION

This application claims priority of U.S. Provisional Patent Application Ser. No. 60/586,443 filed Jul. 8, 2004, which is incorporated herein by reference.

### FIELD OF THE INVENTION

This invention relates to web printed multipage booklets with glossy stock imprinted covers or partial covers, and more particularly to such a booklet in which ads appear on the cover directing attention to ads formed on the interior or back of the booklet.

### BACKGROUND OF THE INVENTION

Certain web printed booklets, such as TV listing guides and catalogs, may consist of a multicolor printed cover or partial cover which extends over at least portions of the front and rear of the booklet and possibly a multicolor insert on glossy stock in the center of the booklet. These multicolor pages typically contain advertisements, and advertisements may additionally be formed on the balance of the pages which are typically of newsprint. The booklets are typically bound adhesively.

Advertisements on the front cover of the booklet have the greatest exposure to viewers, the rear cover pages have somewhat lesser exposure, and the interior pages even lower exposure. Accordingly, the advertising rates for the front cover are the highest, the back cover the next highest, and the intermediate sheets the lowest.

Clearly, it would be advantageous for an entity selling the advertising contained in these booklets to increase the value of ads on the interior pages since there are numerous interior pages but only a single cover and back page.

### SUMMARY OF THE INVENTION

In order to increase the advertising value of the intermediate sheets and/or the back cover of such a booklet, relative to the advertising value of the front cover, the present invention devotes a portion of the front cover and/or alternatively the back cover to “director ads”. These are small ads placed at one margin of the page, preferably the top, and containing a small ad featuring the name of an advertiser on the back or interior pages, and possibly including an arrow and notation such as “See pages 20-21” or the like. A major portion of the page containing such a director ad is devoted to a primary ad on that page.

In this manner the value of the intermediate pages which contain the ads identified on the front or back page are substantially increased in value. Moreover, the value of the primary ad on the front or back pages is not significantly reduced since it still occupies the major portion of those pages.

The present invention is preferably directed toward booklets such as TV schedule guides of the type that are distributed weekly with newspapers. These guides are typically formed with a majority of their interior pages web printed on newsprint. The front and rear pages or partial pages, which cover only a portion of the newsprint booklet, are formed on glossy stock preferably by a web process. Booklets may typically include an interior insert printed on glossy stock by a web process. The booklets are normally adhesively bound. By printing the director ads in multiple colors on the glossy stock, the interior ads, particularly those on the newsprint pages, will be given a heightened prominence and accordingly will bear a substantially higher advertising price. The financial return to the party distributing the booklet and selling the ads will accordingly be substantially improved.

Since the major share of the interior pages on newsprint could be printed in a single color, or two colors, at a relatively low cost, the present invention could substantially increase the advertising value of these low-cost pages.

### BRIEF DESCRIPTION OF THE DRAWINGS

Other objects, advantages and applications of the present invention will be made apparent by the following detailed description of a preferred embodiment of the invention. The description makes reference to the accompanying drawings in which:

FIG. 1 is a perspective view of a multipage, web printed booklet formed in accordance with the present invention in partially open condition; and

FIG. 2 is a partial perspective view of the back page of the booklet of FIG. 1.

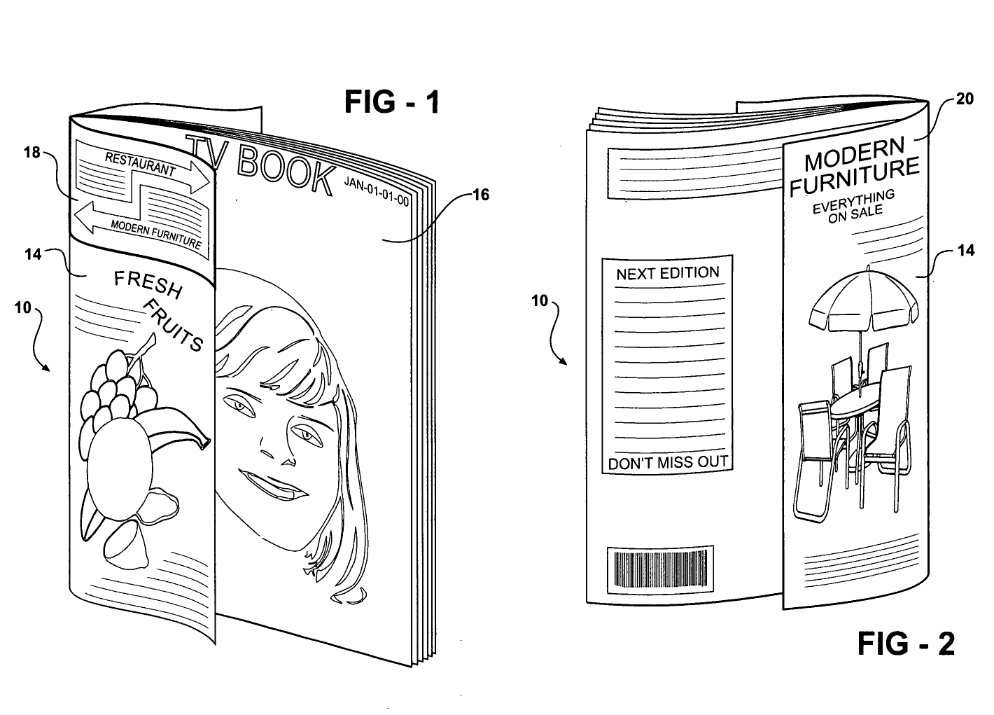

### DETAILED DESCRIPTION OF THE INVENTION

Referring to the drawings, the present invention comprises a multipage booklet formed in a web press. The booklet is generally indicated at 10. A typical booklet may have thirty to sixty interior pages 12 printed on newsprint using a web printing press. Typically, a number of pages, printed on both sides, are formed on the web. The printed sheet is heat set and then folded. Afterwards it is inline adhered and trimmed on three sides to form the interior sheets of the booklet. The exterior sheets, and sometimes center inserts, may be similarly formed on a web press on glossy stock and combined with the newsprint sheets. The combined glossy stock printed cover and back sheet 14 may be folded over the exterior of the booklet. The title of the book may be imprinted on an exterior page 12 of the newsprint. The front cover sheets 14 and rear cover sheets 16 are the most prominently displayed to users of the book 10 and accordingly are imprinted with advertisements that bring a substantially higher price than ads imprinted on the sheets 12 within the interior of the book. The front and rear cover sheets may have the same dimensions as the interior pages 12 and fully cover the front and rear of the booklet 10 or may alternatively cover only a portion of the front or back adjacent to the bound edge.

In accordance with the present invention a cover sheet 14 or back sheet 14 may be imprinted with small ads directing the attention of the reader to ads imprinted in the interior of the booklet. The director ad on the front page 18 and the director ad on the rear page 20 both include arrows pointing to the balance of the book and indicating the page on which the main ad for the purchaser of the director ad is contained. This allows ads formed in the interior of the book to be sold for a higher value because of the prominence provided to them by the director ads on the exterior of the publication.

Having thus described my invention, I claim:

1. A TV guide-type booklet comprising:
a plurality of interior pages printed on newsprint;
at least partial cover pages imprinted on glossy stock covering at least a portion of the exterior pages of the interior pages; and
director ads imprinted on the exteriors of the cover pages advising of the presence of related ads, the director ads identifying pages of the newsprint pages.

2. A multipage, web printed booklet including a plurality of interior pages formed on newsprint and an exterior front and rear cover, imprinted on glossy stock, surrounding at least a portion of the interior pages, with advertisements imprinted on at least a portion of the exterior of the cover identifying the location in the interior of the booklet of other advertisements.

3. The booklet of claim 2 in which the interior pages are numbered and the ads imprinted on the exterior pages identify the location of the ads on the interior pages by page number.

4. The booklet of claim 2 in which the advertisements on the cover pages directing attention to the location of ads on the interior pages include imprinted arrows pointing to the interior pages.

5. The booklet of claim 2 where the pages are bound by inline gluing.

6. A multipage booklet, comprising:
a plurality of interior pages imprinted on newsprint by a web process with the pages sequentially numbered;
a cover sheet imprinted on glossy stock by a web printing process enveloping at least a portion of the first and last newsprint pages;
advertisements imprinted on the exterior sides of the cover page;
advertisements imprinted on at least certain of the interior pages; and
director ads imprinted on the outer side of the glossy cover identifying ads contained on the interior pages by page number.

7. The booklet of claim 6 wherein the pages are bound by inline gluing.
